(19) United States
(12) Patent Application Publication
(10) Pub. No.: US 2026/0108784 A1
(43) Pub. Date: Apr. 23, 2026

(54) INFLATABLE BALL

(71) Applicant: Doskocil Manufacturing Company, Inc., Arlington, TX (US)

(72) Inventors: Josiah Wilhelm, Arlington, TX (US); Ron Bagley, Arlington, TX (US); Chris Wilson, Arlington, TX (US)

(73) Assignee: Doskocil Manufacturing Company, Inc., Arlington, TX (US)

(21) Appl. No.: 19/412,716

(22) Filed: Dec. 8, 2025

Related U.S. Application Data
(63) Continuation of application No. 18/203,996, filed on May 31, 2023, now Pat. No. 12,491,412.
(60) Provisional application No. 63/453,661, filed on Mar. 21, 2023.

(51) Int. Cl. A63B 45/00; A01K 15/02; A63B 41/10

(52) U.S. Cl. CPC A63B 45/00; A63B 41/10; A01K 15/026

(57) ABSTRACT

An inflatable pet toy adopted for use in an inflated state and ambient air state. The inflatable pet toy includes an inner layer, an intermediate layer, and an outer layer. The inner layer forms a selectively inflatable bladder for receiving pressurized air. The inner layer is configured to resist bursting. The intermediate layer coupled to the inner layer. The outer layer substantially surrounds the intermediate layer.

### CROSS-REFERENCE TO RELATED APPLICATIONS

This application is a continuation of U.S. patent application Ser. No. 18/203996, filed on May 31, 2023, which claims priority to Provisional U.S. patent application Ser. No. 63/453,661, filed on Mar. 21, 2023, both of which are incorporated herein by reference in their entireties.

### TECHNICAL FIELD

The present disclosure generally relates to an inflatable ball. More specifically, the present disclosure relates to an inflatable ball having multiple layers.

### SUMMARY

An inflatable ball can be considered “anti-burst” or “burst-resistant,” meaning the inner layer would deflate if punctured but not explode. In this way, the inflatable ball can maintain its inflated shape not by the air pressure filled inside the bladder but due to the rigidity and elasticity of the PVC. The inflatable ball can withstand semipermanent use without requiring much care. As stated, the inner layer can be made of foamed polyvinyl chloride to have suitable flexibility. Therefore, the inflatable ball can absorb impact and not cause injury to a pet during engagement.

In view of the state of the known technology, one aspect of the present disclosure is to provide an inflatable ball comprising an inner layer, an intermediate layer and an outer layer. The inner layer has an inflatable bladder for storing air. The intermediate layer is provided over the inner layer, the intermediate layer including ethylene vinyl acetate. The outer layer is provided over the intermediate layer. The outer layer includes rubber.

One embodiment relates to an inflatable pet toy adapted for use in an inflated state and ambient air state including an inner layer forming a selectively inflatable bladder for receiving pressurized air, an intermediate layer coupled to the inner layer, and an outer layer covering the intermediate layer. The inner layer is configured to resist bursting during engagement with a pet.

Another embodiment relates to a method for making an inflatable pet toy adapted for use in an inflated state and an ambient air state. The method includes forming an inner layer into a selectively inflatable bladder for receiving pressurized air. The inner layer is configured to resist bursting during engagement with a pet. The method includes forming an intermediate layer over the inner layer. The intermediate layer coupled to the inner layer. The method includes forming an outer layer over the intermediate layer. The outer layer is coupled to the intermediate layer.

Yet another embodiment relates to an inflatable pet toy adapted for use in an inflated state and ambient air state including an inner layer, an intermediate layer, and an outer layer. The inner layer forms a selectively inflatable bladder for receiving pressurized air. In an inflated state after receiving pressurized air, the pet toy substantially assumes a desired shape and the pet toy substantially retains the desired shape when the pet toy is in the ambient air state in part as a result of a material property of the inner layer. The intermediate layer is coupled to the inner layer. The outer layer is coupled to the intermediate layer.

### BRIEF DESCRIPTION OF THE DRAWINGS

Referring now to the attached drawings which form a part of this original disclosure:

FIG. 1 is a plan view of an inflatable ball in accordance with an illustrated embodiment;

FIG. 2 is a plan view of the inflatable ball of FIG. 1 but with an outer layer of the inflatable ball partially broken away to show an inner bladder;

FIG. 3 is a cross-sectional view of the inflatable ball of FIG. 1;

FIG. 4 is an enlarged view of a portion Al of the cross-sectional view of FIG. 3;

FIG. 5 is an enlarged view of a portion A2 of the cross-sectional view of FIG. 3; and

FIG. 6 is a plan view of an alternative inflatable ball having different outer rubber panels.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

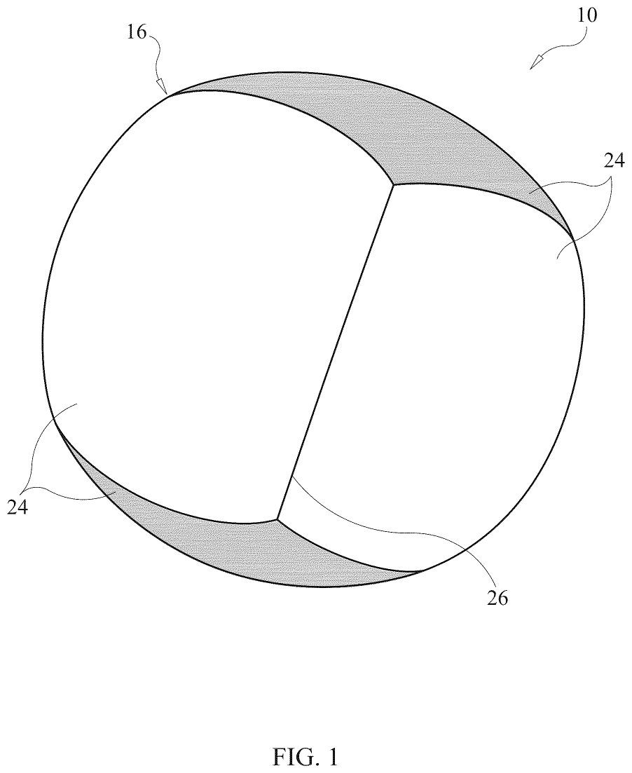

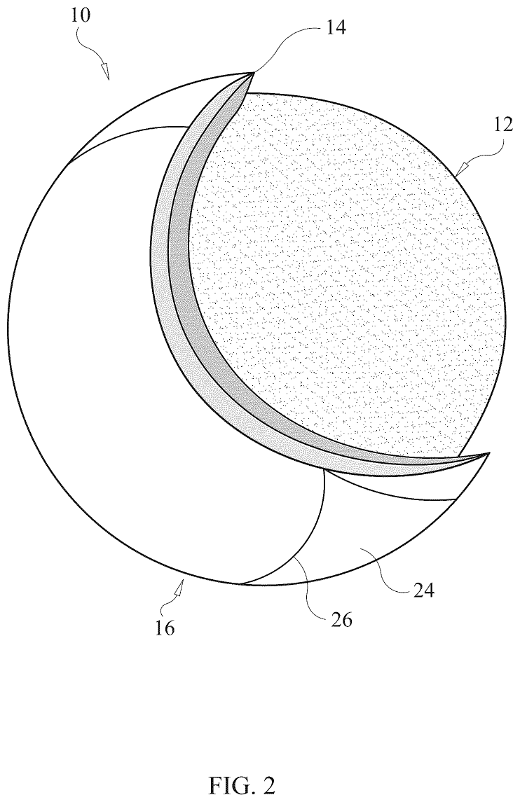

Referring initially to FIGS. 1 to 2, an inflatable ball 10 comprises an inner layer 12, an intermediate layer 14 and an outer layer 16. The inner layer 12 has a cavity C for storing air. The intermediate layer 14 is provided over the inner layer 12. In the illustrated embodiment, the intermediate layer 14 includes ethylene vinyl acetate (EVA), as will be further described below. The outer layer 16 is provided over the intermediate layer 14. In the illustrated embodiment, the outer layer 16 includes rubber, preferably vulcanized rubber as will be described below. In the inflated state, the inflatable ball 10 preferably has a size ranging from 45 centimeters to 85 centimeters. However, it is noted that the ball 10 can have any suitable size, shape and/or diameter. The inner, intermediate and outer layers 12, 14 and 16 are provided as flexible but durable layers that can contract and expand as the inflatable ball 10 moves between the inflated and deflated states.

Therefore, the inflatable ball 10 of the illustrated embodiment includes three layers. The inner layer 12 is highly expandable to be inflated. The intermediate layer 14 having EVA strengthens the inflatable ball 10 to keep the inflatable ball 10 from puncturing during animal engagement. The outer layer 16 includes rubber or other rough material to give the inflatable ball 10 an outer texture that is similar to a soccer ball or a volleyball to engage the animal. Therefore, the inflatable ball 10 is suitable for animal engagement that is provided to not be punctured easily.

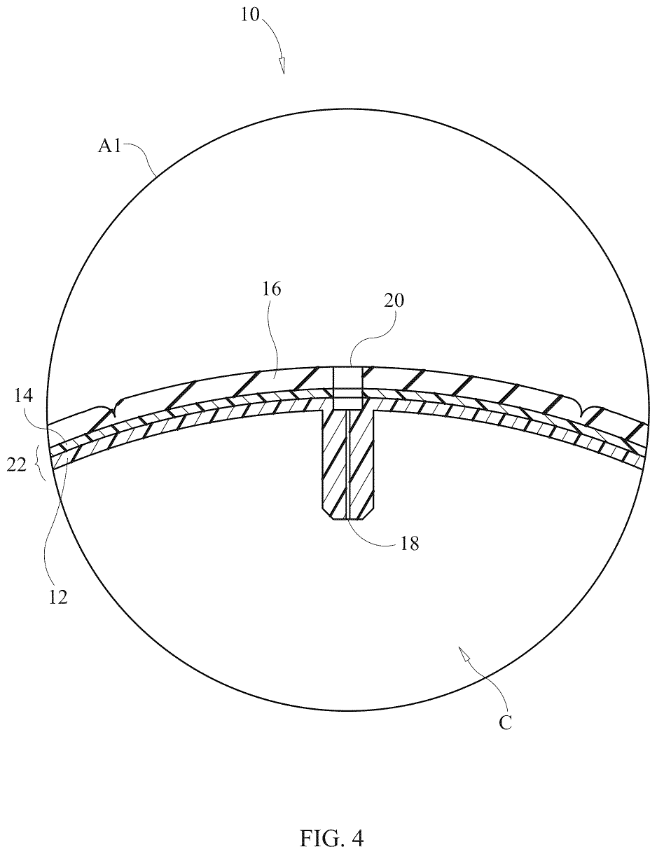

As best seen in FIG. 4, the inflatable ball 10 includes a valve 18 for receiving a pump (not shown) to inflate the inflatable ball 10. The inflatable ball 10 also includes a plug 20 that is fitted over the valve 18 to close the valve 18 once the ball is inflated. As shown, the valve 18 extends through the inner, intermediate and outer layers 12, 14 and 16 so that air can reach the cavity C from the pump. The ball can be inflated in any suitable manner with or without a pump.

As stated, the inner layer 12 forms the cavity C for containing the air. In the illustrated embodiment, the inner layer 12 is made of polyvinyl chloride (PVC). That is, the inner layer 12 can be made of soft plastic vinyl. The inner layer 12 can be made of a non-toxic PVC material with a thickness of about 1500 to 2000 micrometers. Preferably, the inner layer 12 is approximately 1800 micrometers. In this way, the inner layer 12 can be puncture resistant when a pet engages with the inflatable ball 10. The inner layer 12 can be made from the polymerization of vinyl chloride to form an unmodified PVC layer that can be inflated with air. The unmodified PVC layer is then applied with additives such as heat or ultraviolet (UV) stabilizers, and impact modifiers, and/or flame retardants.

With the inner layer 12 being made of PVC, the inflatable ball 10 can be considered “anti-burst” or “burst-resistant,” meaning the inner layer 12 would deflate if punctured but not explode. In this way, the inflatable ball 10 can maintain its inflated shape not by the air pressure filled inside the bladder 22 but due to the rigidity and elasticity of the PVC. The inflatable ball 10 can withstand semi-permanent use without requiring much care. As stated, the inner layer 12 can be made of foamed PVC to have suitable flexibility. Therefore, the inflatable ball 10 can absorb impact and not cause injury to a pet during engagement.

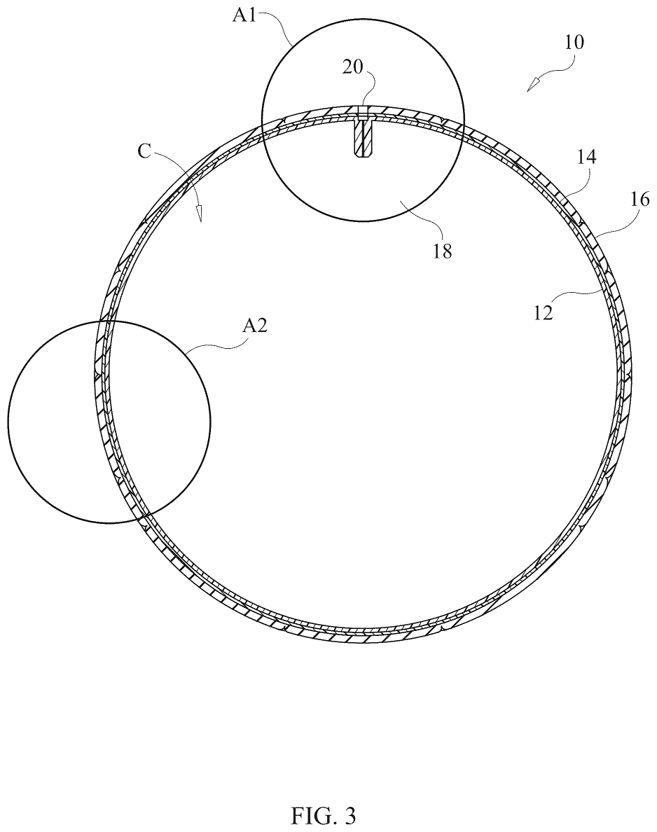

As shown in FIG. 3, the inner layer 12 defines the cavity C that is a substantially spherical cavity C formed at the center of the inflatable ball 10. The inner layer 12 can be formed by applying a water-resistant film containing an acrylic resin onto a spherical mold that forms the cavity C. The raw material for the foamed PVC can be kneaded into a paste that is charged onto the mold. The PVC can also be coated onto the mold by spray coating the surface of the mold.

Referring to FIGS. 2 to 4, the intermediate layer 14 is EVA or made from EVA. Therefore, the intermediate layer 14 can be made of a copolymer of ethylene and vinyl acetate. The intermediate layer 14 is therefore made of extremely elastic material that can be processed like other thermoplastics. The intermediate layer 14 also possesses physical qualities of low-temperature toughness, stress-crack and UV radiation resistance. The intermediate layer 14 with EVA can have a tensile strength of 3580 psi and a flexural modulus of elasticity of 2470 psi. The intermediate layer 14 can be provided over the inner layer 12 by spray painting EVA foam over the inner layer 12. Alternatively, the intermediate layer 14 can be injection molded onto the inner layer 12. As seen in FIGS. 3 to 5, the intermediate layer 14 is preferably thinner than the inner and outer layers 14 and 16. Therefore, the intermediate layer 14 is the thinnest layer.

In the illustrated embodiment, the intermediate layer 14 can be made of ethylene vinyl acetate copolymer, ethylene vinyl acetate/acid terpolymer, or mixtures of these, along with a crosslinking agent, crosslinking activator, crosslinking accelerator, co-crosslinking agent, or mixtures of these. The intermediate layer 14 can have vinyl acetate content between about 5% and about 60%. The intermediate layer 14 can also comprise of a blend polymer, which can include ionomeric polymers, nonionomeric polymers, or mixtures of these. The intermediate layer 14 can also include a crosslinking agent, activator, accelerator, co-crosslinking agent, or mixtures of these.

The intermediate layer 14 can include different types of EVA copolymers and EVA/acid terpolymers having widely varying physical properties based on their differing vinyl acetate content and molecular weight. These various combinations of vinyl acetate content and molecular weight provide for many different types of these polymers having very different processability, as well as other chemical, thermal, mechanical, and rheological properties. The intermediate layer 14 within the scope of the present invention includes ethylene vinyl acetate copolymers and/or ethylene vinyl acetate/acid terpolymers having a percentage content of vinyl acetate between about 5% and about 60%.

The intermediate layer 14 as applied over the inner layer 12 together forms the bladder 22 of the inflatable ball 10. In other words, the inner layer 12 and the intermediate layer 14 together defines the bladder 22, as seen in FIG. 2. It will be apparent to those skilled in the pet products field from this disclosure that the layers of the inner, intermediate and outer layers 12, 14 and 16 can vary depending on need or desire of the overall dimensions of the inflatable ball 10.

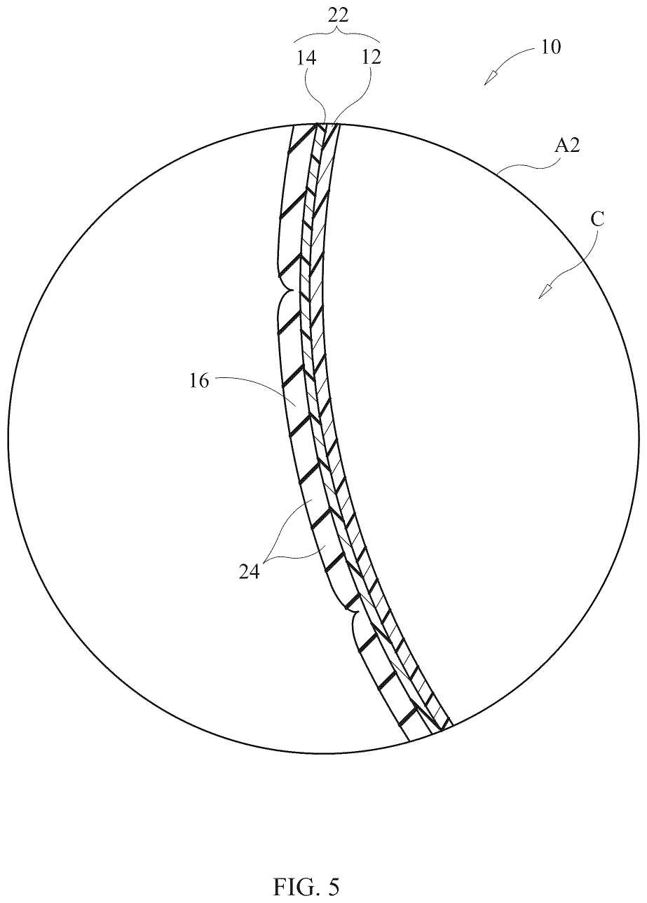

The outer layer 16 can comprise of a plurality of rubber panels 24 that are connected to give the inflatable ball 10 texture and grip. As stated, the outer layer 16 is made of rubber, preferably vulcanized rubber. Alternatively, the outer layer 16 can be made of synthetic leather, such as plastics or polyurethane that is water resistant. As shown in FIGS. 1 and 5, the outer layer 16 is provided as a plurality of rubber panels 24 that can be stitched together in a conventional manner.

When the rubber panels 24 are sewn together, the inflatable ball 10 is a near perfect sphere in the inflated state. However, it is noted that the ball can have any suitable “ball” shape, such as a football, rugby ball or other type of “sports” ball. The outer layer 16 can also include multiple layers of polyester lining or cotton blend lining which give the inflatable ball 10 strength, structure, and bounce. The rubber panels 24 of the outer layer 16 can be stitched with a 5-ply twisted polyester cord, machine-stitched or glued together. The rubber panels 24 are preferably cut into the desired shapes and sizes and pre-punched with holes for stitching 26. The stitching 26 is done by turning the ball inside out so none of the stitches show on the outside of the inflatable ball 10. The finished ball is reversed and the bladder 22 (i.e., the inner and intermediate layer 14s) is inserted and inflated to be sure the needle does not puncture the bladder 22. While the outer layer 16 is provided to give the inflatable ball 10 the appearance of a soccer ball. It will be apparent to those skilled in the pet products field from this disclosure that alternatively, the outer layer 16 can be provided to give the inflatable the outer appearance of a volleyball or other type of ball as needed and/or desired.

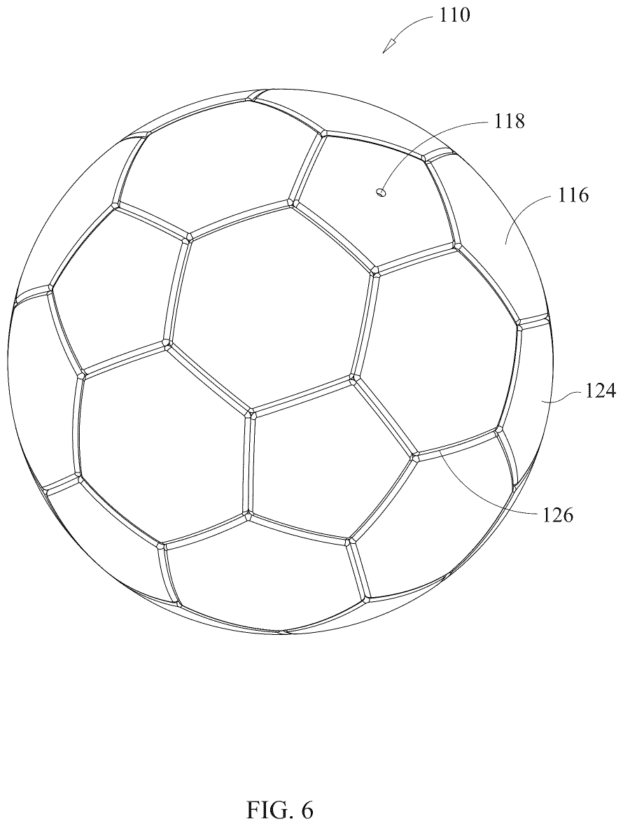

Referring to FIG. 6, a modified inflatable ball 110 is provided having a modified outer layer 116. The modified inflatable ball 110 is identical with the inflatable 10 and has an inner layer and an intermediate layer that are identical to the inner layer 12 and the intermediate layer 14 of the inflatable ball 10. The modified inflatable ball 110 includes a modified valve 118 that extends through the modified outer layer 116 towards the cavity of the modified inflatable ball 110. The modified outer layer 116 is also preferably made of vulcanized rubber as the outer layer 16. However, the modified outer layer 116 includes a plurality of modified panels 124. As shown in FIGS. 1 and 5, the outer layer 16 is provided as a plurality of rubber panels 124 that that are stitched together to give the inflatable ball 110 the outer appearance of a soccer ball. Therefore, the rubber panels 124 are provided as hexagons that are stitched or glued together. It will be apparent to those skilled in the pet products field from this disclosure that the panels 24 and 124 can be provided in various shapes, sizes and dimensions to give the inflatable ball 10 and the modified inflatable ball 110 varying appearances.

In understanding the scope of the present invention, the term “comprising” and its derivatives, as used herein, are intended to be open ended terms that specify the presence of the stated features, elements, components and/or groups, but do not exclude the presence of other unstated features, elements, components and/or groups. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section or part of a device includes that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An inflatable pet toy adapted for use in an inflated state and ambient air state comprising:
an inner layer forming a selectively inflatable bladder for receiving pressurized air, the inner layer configured to resist bursting;
an intermediate layer coupled to the inner layer; and
an outer layer substantially surrounding the intermediate layer.

2. The inflatable pet toy according to claim 1, wherein the intermediate layer substantially surrounds the inner layer.

3. The inflatable pet toy according to claim 1, wherein the outer layer substantially surrounds the intermediate layer.

4. The inflatable pet toy according to claim 1, wherein the intermediate layer has a substantially uniform thickness.

5. The inflatable pet toy of claim 1, wherein:
the inner layer has an inner layer thickness;
the intermediate layer has an intermediate layer thickness; and
the outer layer has an outer layer thickness, the intermediate layer thickness being less than both the inner layer thickness and the outer layer thickness.

6. The inflatable pet toy according to claim 1, wherein the inner layer has an inner layer thickness ranging from approximately 1500 to 2000 micrometers.

7. The inflatable pet toy of claim 6, wherein:
the intermediate layer has an intermediate layer thickness; and
the outer layer has an outer layer thickness, the intermediate layer thickness being less than the outer layer thickness.

8. The inflatable pet toy according to claim 6, wherein the intermediate layer has an intermediate layer thickness being less than the inner layer thickness.

9. The inflatable pet toy of claim 1, wherein in a fully inflated state the inflatable pet toy has a size ranging from about 55 centimeters to 85 centimeters.

10. The inflatable pet toy according to claim 1, wherein the outer layer is formed from a plurality of coupled rubber panels.

11. The inflatable pet toy according to claim 1, wherein the inner layer is adapted to receive pressurized air to transition from the ambient air state to the inflated state.

12. The inflatable pet toy of claim 1, wherein in the inflated state, the pet toy substantially assumes a desired shape and the pet toy substantially retains the desired shape when the pet toy is in the ambient air state in part as a result of a material property of the inner layer.

13. The inflatable pet toy of claim 1, wherein the intermediate layer includes ethylene vinyl acetate foam sprayed over the inner layer.

14. A method for making an inflatable pet toy adapted for use in an inflated state and an ambient air state, the method comprising:
forming a selectively inflatable bladder for receiving pressurized air, the inflatable bladder configured to resist bursting;
forming an intermediate layer which substantially surrounds the inflatable bladder, the intermediate layer being coupled to the inflatable bladder; and
forming an outer layer which substantially surrounds the intermediate layer, the outer layer being coupled to the intermediate layer.

15. The method of claim 14, wherein:
the inflatable bladder has an inflatable bladder thickness;
the intermediate layer has an intermediate layer thickness; and
the outer layer has an outer layer thickness, the intermediate layer thickness being less than both the inflatable bladder thickness and the outer layer thickness.

16. The method of claim 14, wherein the intermediate layer substantially encapsulates the inflatable bladder.

17. The method of claim 14, wherein the outer layer contacts the intermediate layer.

18. The method of claim 14, wherein the inflatable bladder has an inflatable bladder thickness ranging from approximately 1500 to 2000 micrometers.

19. The method of claim 18, wherein:
the intermediate layer has an intermediate layer thickness; and
the outer layer has an outer layer thickness, the intermediate layer thickness being less than the outer layer thickness.

20. An inflatable pet toy adapted for use in an inflated state and ambient air state comprising:
an inflatable bladder for selectively receiving pressurized air, after receiving pressurized air, the pet toy is in the inflated state and substantially assumes a desired shape, and substantially retains the desired shape when the pet toy is in the ambient air state in part as a result of a material property of the inflatable bladder;
an intermediate layer coupled to the inflatable bladder; and
an outer layer coupled to the intermediate layer.
